(19) United States
(12) Patent Application Publication
(10) Pub. No.: US 2010/0319199 A1
(43) Pub. Date: Dec. 23, 2010

(54) Cutters for Accessing a Fiber within a Fiber Optic Cable to Splice Thereto and Tools and Methods Using the Same

(75) Inventors: Julian Mullaney, Raleigh, NC (US); Justin Everette Thompson, Angier, NC (US)

Correspondence Address: Tyco Electronics Corporation-;Intellectual Propery Law Department, 309 Constitution Drive, M/S R34 2A, Menlo Park, CA, 94025-1164, US

(73) Assignee: Tyco Electronics Corporation

(21) Appl. No.: 12/732,697

(22) Filed: Mar. 26, 2010

Related U.S. Application Data
(60) Provisional application No. 61/187,922, filed on Jun. 17, 2009.

(51) Int. Cl. H02G 1/12; B26B 27/00; B26B 9/00

(52) U.S. Cl. 30/91.1; 30/90.4; 30/357; 29/426.4

(57) ABSTRACT

Apparatus for accessing a length of a selected one or more of a plurality of optical fibers within an outer protective jacket of a cable including the plurality of optical fibers and at least one strength member extending along a longitudinal axis of the cable include a cutting member and a cutter blade positioned in the cutting member. The cutter blade has a cutting edge with a middle region of a first sharpness and outer side regions adjacent opposite sides of the middle region of a second sharpness that is sharper than the first sharpness.

### RELATED APPLICATIONS

The present application claims the benefit of and priority from U.S. Provisional Application No. 61/187,922, (Attorney Docket No. TO-00312-US/5487-300PR), filed Jun. 17, 2009, the disclosure of which is hereby incorporated herein in its entirety by reference.

### BACKGROUND OF THE INVENTION

The present invention relates to communication cable termination systems and, more particularly, to optical fiber termination systems and methods for terminating the same.

An extensive infrastructure supporting telecommunication has been developed, traditionally based upon copper wire connections between individual subscribers and telecommunications company network distribution points. More recently, much of the telecommunications network infrastructure is being extended or replaced with an optical fiber based communications network infrastructure. The carrying capacity and communication rate capabilities of such equipment may exceed that provided by conventional copper wired systems.

As such, fiber optic cables are widely used for telecommunications applications where high information capacity, noise immunity and other advantages of optical fibers may be exploited. Fiber cable architectures are emerging for connecting homes and/or business establishments, via optical fibers, to a central location, for example. A trunk or main cable may be routed, for example, through a housing subdivision and small fiber count “drop cables” may be spliced to the main cable at predetermined spaced apart locations.

A typical main cable may be installed underground and have multiple drop cables connected thereto, each of a hundred feet or more. Each of the drop cables, in turn, may be routed to an optical network unit (ONU) serving several homes. Information may then be transmitted optically to the ONU, and into the home, via conventional copper cable technology, although it also has been proposed to extend optical fiber all the way to the home rather than just to the ONU. Thus, the drop cables may serve groups of users, although other architectures may also employ a main cable and one or more drop cables connected thereto.

Unfortunately, the fibers within the main cable must typically be accessed at the various drop points and spliced to respective drop cables after the main cable has already been installed. Accessing the main cable for splicing generally requires careful preparation of the main cable including removing a portion of the cable sheath, and identifying and separating out predetermined fibers from within the cable without disturbing adjacent fibers. The separated fibers may then be spliced and secured within a conventional protective splice closure. Moreover, these cable access and splicing steps must typically be accomplished in the field by a technician who is likely to experience difficulties imposed by weather or the particular location of each of the drop points. Accordingly, field splicing of drop cables to a main cable is typically time consuming, expensive, and may produce low quality optical splices.

In addition, traditional methods of accessing the fibers inside a fiber optic cable typically involve removing some of the outer sheath (protective jacket) manually using a knife in order to gain access to a rip cord that is built into the cable between the outer protective jacket and the central core tube. Once this rip cord is exposed, it can be pulled along the longitudinal (lengthwise) axis of the cable for the purpose of splitting the outer protective jacket. This is the conventional method of allowing the outer jacket to be totally removed over the length of cable that needs to be used. Typically, this is a several foot long lengthwise segment of the outer jacket. After the outer protective jacket is removed, then the central core tube is split open to gain access to the actual fibers (or fiber ribbons) inside the central core tube. Typically, this is done with various different tools available in the industry for this purpose. These tools typically use some sort of cutting (cutter) blade that penetrates the core tube and is then pulled along the axis of the tube to slit the tube. These devices are generally very sensitive to individual adjustments, and sometimes damage the delicate fibers during the process of splitting the tube. The reason they can cause damage is that the sharp blades designed to cut the central core tube can also slice portions of the fiber jacketing and even sever fibers in severe cases.

### SUMMARY OF THE INVENTION

Some embodiments of the present invention include an apparatus for accessing a length of a selected one of a plurality of optical fibers within an outer protective jacket of a cable including the plurality of optical fibers and at least one strength member extending along a longitudinal axis of the cable. The apparatus includes a cutting member and a cutter blade. The cutter blade is positioned in the cutting member and has a cutting edge with a middle region of a first sharpness and outer side regions adjacent opposite sides of the middle region of a second sharpness that is sharper than the first sharpness.

In other embodiments, the apparatus further includes a cable positioning fixture configured to receive a portion of the cable therein and to establish a desired rotational orientation of the portion of the cable in the fixture relative to the at least one strength member therein while the cutter blade is longitudinally advanced along the portion of the cable to remove a scalloped segment from the outer protective jacket. The cable may further include a central core tube and the at least one strength member may be a pair of strength members extending along opposite sides of the cable and the plurality of optical fibers may be within the central core tube and the pair of strength members is outside the central core tube.

In further embodiments, the first sharpness of the middle region is selected to be sharp enough, when advanced at an angle relative to the longitudinal axis of the cable to puncture through the outer protective jacket but not sharp enough to damage the optical fibers while removing a scalloped segment from the cable. The second sharpness of the outer side regions is selected to be sharp enough to slice through the outer protective jacket when advanced substantially parallel to the longitudinal axis of the cable. The first sharpness of the middle region may be selected to be sharp enough, when advanced at an angle relative to the longitudinal axis of the cable to puncture through the central core tube. The middle region of the cutting edge may have a radius at the cutting edge of between about 0.001 and 0.015 inches in radius and the outer side regions may be razor sharp.

In other embodiments, the apparatus further includes a gating device configured to limit lateral movement of the cutter blade relative to the longitudinal axis of the cable to maintain the middle region of the cutting edge substantially centered relative to the longitudinal axis of the cable and to maintain the outer side regions transversely substantially outside of the central core tube when the cutting device is moved along the longitudinal axis of the cable to remove a scalloped segment from the outer protective jacket. The gating device may be a cable centering fixture coupled to the cutting member and having first and second retaining arms positioned to receive the cable therebetween to limit lateral movement of the cable relative to the cutting member. The first and second retaining arms may be spring steel members with a lateral distance therebetween selected to receive a selected range of diameters of cables.

In other embodiments, the cutting member is configured to automatically pivot between a first position aligning the cutter blade therein to penetrate the cable at an angle of between about 10 and 50 degrees inclination relative to the longitudinal axis of the cable and a second position aligning the cutter blade therein substantially parallel to the longitudinal axis of the cable after penetrating the cable outer jacket and the central core tube. The cutting member may be configured to automatically pivot between the first position and the second position responsive to contact of the cutter blade with the pair of strength members. The cutting member may also be configured to pivot from the second position to a third position aligning the cutter blade therein to exit the cable at an angle of between about 10 and 50 degrees.

In yet further embodiments, the cable positioning fixture further includes a cutting member receiving portion configured to rotationally mount the cutting member in the fixture about a rotation axis. A clock spring member is positioned on the rotation axis. The clock spring member has a retaining tab at one end thereof and a selection lever at a second, opposite end thereof. The cable positioning fixture further includes a channel having a first stop end and an opposite second stop end. The retaining tab of the clock spring member is positioned proximate the channel. The cutting member further includes a rotational travel limit member positioned in the channel that limits rotary movement of the cutting member about the rotation axis by contact of the travel limiter with the first stop end of the channel when the cutting member is in the first position and with the second stop end of the channel when the cutting member is in the third position. The cutting member is configured to connect to the retaining tab of the spring member. The selection lever of the spring member is movable between a first position, in which the spring member places an amount of torque on the cutting member sufficient to move the cutting member to the third position to exit the cable, and a second position, in which the spring member does not place enough torque on the cutting member to move the cutting member to the third position. The cutting member may be a molded plastic member and the cutting blade may be molded into the cutting member.

In other embodiments, the desired rotational orientation is with the opposite sides of the cable including the strength members extending in a plane with each of the strength members displaced by a substantially same vertical distance from a path followed by the cutting member relative to the portion of the cable when removing the scalloped segment so that a vertical position of the strength members in the portion of the cable relative to a path followed by the cutting member limits a vertical depth of the scalloped segment by substantially concurrent mechanical interference of the cutter blade with both of the strength members.

In other embodiments, a cutter blade is provided for accessing a length of a selected one of a plurality of optical fibers within an outer protective jacket of a cable including the plurality of optical fibers and at least one strength member extending along a longitudinal axis of the cable. The cutter blade has a cutting edge with a middle region of a first sharpness and outer side regions adjacent opposite sides of the middle region of a second sharpness that is sharper than the first sharpness. The first sharpness of the middle region is selected to be sharp enough, when advanced at an angle relative to the longitudinal axis of the cable to puncture through the outer protective jacket but not sharp enough to damage the optical fibers. The second sharpness of the outer side regions is selected to be sharp enough to slice through the outer protective jacket when advanced substantially parallel to the longitudinal axis of the cable. The middle region of the cutting edge may have a radius at the cutting edge of between about 0.001 and 0.015 inches in radius and the outer side regions may be razor sharp. The outer side regions of the cutting edge may extend at an angle away from the middle region. The outer side regions of the cutting edge may be between about 50 percent and about 300 percent sharper than the middle region.

In yet other embodiments, an apparatus for accessing a length of a selected one of a plurality of optical fibers within an outer protective jacket of a cable including the plurality of optical fibers and at least one strength member extending along a longitudinal axis of the cable includes a cutting member and a cutter blade in the cutting member. The cutter blade is configured to puncture through the outer protective jacket of the cable at an angle relative to the longitudinal axis of the cable and to slice through the outer protective jacket when advanced substantially parallel to the longitudinal axis of the cable without damaging the optical fibers while removing a scalloped segment from the cable.

In further embodiments, a method of accessing an optical fiber within an optical fiber cable includes accessing a portion of the cable at a selected location. The portion of the cable is arched while allowing rotation about a central axis of the cable to establish a desired rotational orientation of the portion of the cable relative to the pair of strength members of the cable. A scalloped segment of the outer protective jacket is removed at a selected location on the portion of the cable while the portion is in the desired rotational orientation without cutting any of the plurality of optical fibers or the pair of strength members to provide an opening. Removal of the scalloped segment includes advancing a cutting member into the cable with an edge of a cutter blade in the cutting member at an angle of between about 10 and 50 degrees inclination relative to the longitudinal axis of the cable until the cutter blade contacts the pair of strength members. The cutting member is then advanced longitudinally along the cable with the edge of the cutter blade substantially parallel to the longitudinal axis of the cable after penetrating the cable outer jacket. Then the cutter blade is exited from the cable at an angle of between about 10 and 50 degrees inclination relative to the longitudinal axis of the cable after a desired length of the outer jacket has been removed to provide a selected size for the opening.

The desired rotational orientation is with the opposite sides of the cable including the strength members positioned at a substantially same vertical position relative to a cutting member used to remove the scalloped segment. Removing the scalloped segment includes forming the opening with the cutting member to a vertical depth not exceeding the vertical position of the strength members in the portion of the cable. The cutting edge includes a middle region of a first sharpness and outer side regions adjacent opposite sides of the middle region of a second sharpness that is sharper than the first sharpness.

### BRIEF DESCRIPTION OF THE DRAWINGS

FIG. 1A is a schematic cross-sectional side view of a cutter blade in a fiber optic cable in a first position according to some embodiments of the present invention;

FIG. 1B is a schematic end view of the cutter blade in the fiber optic cable of FIG. 1A;

FIG. 1C is a schematic end view of the cutter blade of FIG. 1A;

FIG. 2A is a schematic cross-sectional side view of a cutter blade in a fiber optic cable in a second position according to some embodiments of the present invention;

FIG. 2B is a schematic end view of the cutter blade and fiber optic cable of FIG. 2A;

FIG. 2C is a perspective view of the cutter blade and fiber optic cable of FIG. 2A.

FIG. 3A is a partial perspective view illustrating an apparatus for accessing a length of a selected one of a plurality of optical fibers within an outer protective jacket of a cable showing a cutting member for cutting into the cable according to some embodiments of the present invention.

FIG. 3B is a perspective view showing in detail features within the cable and further illustrating methods of accessing optical fiber within an optical fiber cable according to some embodiments of the present invention.

FIG. 4A is a perspective view of an apparatus for accessing a length of a selected one of a plurality of optical fibers within an outer protective jacket of a cable according to further embodiments of the present invention:

FIG. 4B is a plan view of the apparatus of FIG. 4A.

FIG. 5A is a perspective view of an apparatus for accessing a length of a selected one of a plurality of optical fibers within an outer protective jacket of a cable according to other embodiments of the present invention.

FIG. 5B is a partially exploded perspective view of the apparatus of FIG. 5A.

FIG. 5C is a partially exploded perspective view of the apparatus of FIG. 5A.

FIG. 6A is a perspective view of the apparatus of FIG. 5A showing the selection lever in a first position and the cutting member in a first position.

FIG. 6B is a schematic plan view of the apparatus of FIG. 6A.

FIG. 7A is a perspective view of the apparatus of FIG. 5A showing the selection lever in the first position and the cutting member in a second position.

FIG. 7B is a schematic plan view of the apparatus of FIG. 7A.

FIG. 8A is a perspective view of the apparatus of FIG. 5A showing the selection lever in a second position and the cutting member in a third position.

FIG. 8B is a schematic plan view of the apparatus of FIG. 8A.

FIG. 9 is a flowchart illustrating operations for accessing a length of a selected one of a plurality of optical fibers within an outer protective jacket of a cable according to some embodiments of the present invention.

FIG. 10 is a perspective view of a cutter blade according to further embodiments of the present invention.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

Some embodiments of the present invention provide for accessing a fiber within a fiber optic cable, such as a fiber optic cable that includes a plurality of fibers therein, which may be ribbon fibers including a plurality of fibers in a ribbon arrangement, strength members and/or shielding. Embodiments of the present invention provide methods and tools that may allow for more easily entering and accessing one or several fibers within an outside plant fiber optic cable.

Thus, methods are provided of bending a central core tube type fiber optic cable around a mandrel, such that the dual strength members of the cable become oriented along the neutral axis of bending of the cable (i.e., at 3 and 9 o'clock with respect to the cross section of the cable), which allows a scalloping tool to follow an approximately arcuate path along or near the neutral axis of the cable for a distance and to ride along the strength members, which may, thus, limit or even prevent the scalloping tool from cutting more than half of the cable jacket away and limit or even prevent any damage to the fibers in the core tube by the scalloping tool. After splicing or the like, environmental integrity of the cable may be restored by applying a closure over each opening.

Some embodiments of the present invention provide a cutting (cutter) blade and cutting device including the same for accessing optical fibers in the central core tube of, for example, an outside plant variety of fiber optic cable and methods for using the same. Some embodiments of the cutter blade described herein may be used, for example, with the tools and methods described in co-pending U.S. patent application Ser. No. 12/194,178, filed Aug. 19, 2008 (“the '178 Application”), which is hereby incorporated herein by reference as if set forth in its entirety.

Some embodiments of the present invention may limit or even prevent cutting or damaging the underlying optical fibers in a fiber optic cable as will now be described. In some embodiments, a cutting device is configured to initially orient a cutter blade therein to penetrate the cable at an angle of between about 10 and 50 degrees inclination relative to the cable longitudinal (lengthwise) axis. After penetrating the cable outer jacket and central core tube, the cutting device may be configured to automatically adjust the attitude (angle relative to the cable axis) of the cutter blade, such that the cutter blade is oriented substantially parallel to the axis of the cable. The cutting device may then be moved in a direction parallel to the longitudinal axis of the cable (i.e., along the longitudinal axis) in order to traverse the selected length of cable where access is desired. Furthermore, the cutter blade may be automatically angled upwards by the cutting device away from the cable axis at a similar upwards inclination of approximately between 10 and 50 degrees to exit the cable. As a result, a scalloped segment may be removed from the cable to allow access to the fibers without cutting the strength members or the remaining portions of the cable. As used herein, a “scalloped segment” is a longitudinally extending partial section removed from the cable with a downwardly angled entry portion at one end, a middle section with a substantially consistent cross section, and an exit portion with an upwardly angled portion. The entry portion and exit portion leave curved edges in the remaining cable section in the entry and exit areas respectively.

In other words, in some embodiments, the cutter blade has sharp portions that are positioned just outside the central core tube of a fiber optic cable that cut the cable outer jacket and other fibrous materials, such as ripcords, Kevlar cords, paper wrappers, etc. A duller section of the cutter blade is sharp enough to cut the central core tube when making the longitudinal cut, generally because the central core tube is made of softer plastic and has a relatively thin wall thickness. As such the dullness/sharpness may be controlled on the center portion of the cutter blade so that it can cut the thin walled central core tube not only on initial cable entry, but also during the generally longer straight cut while moving along the longitudinal axis of the cable. The sharp sections of the blade are primarily provided for cutting the outer cable jacket and the fibrous materials which lie in between the outer jacket and the inner central core tube. These materials may bunch up when cutting unless the blade in that area is so sharp that it may also damage optical fibers if brought into contact with the fibers.

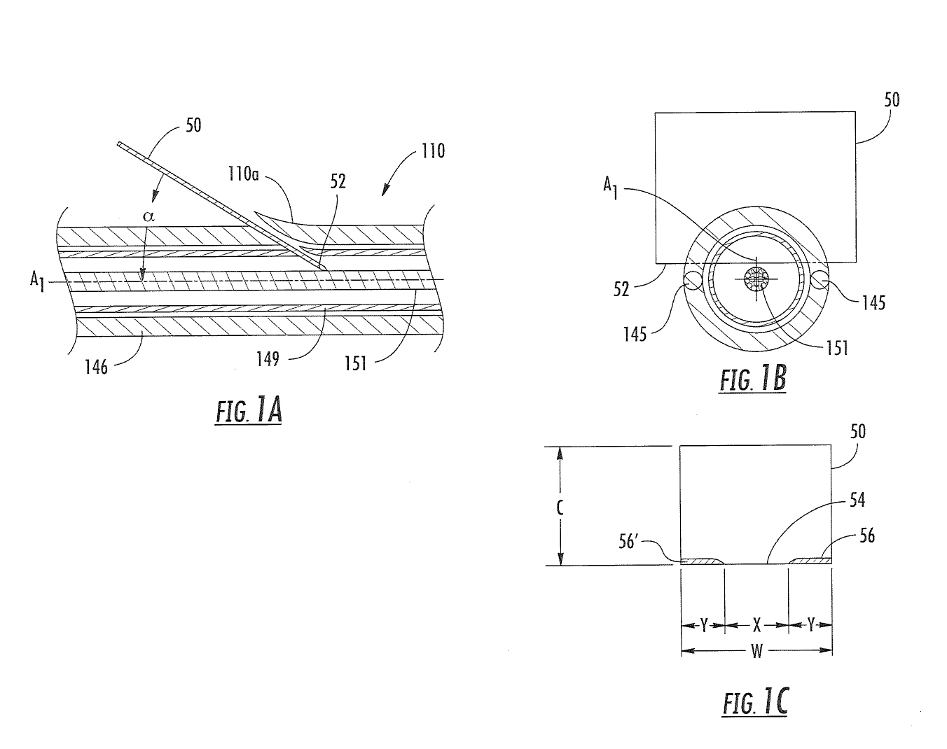

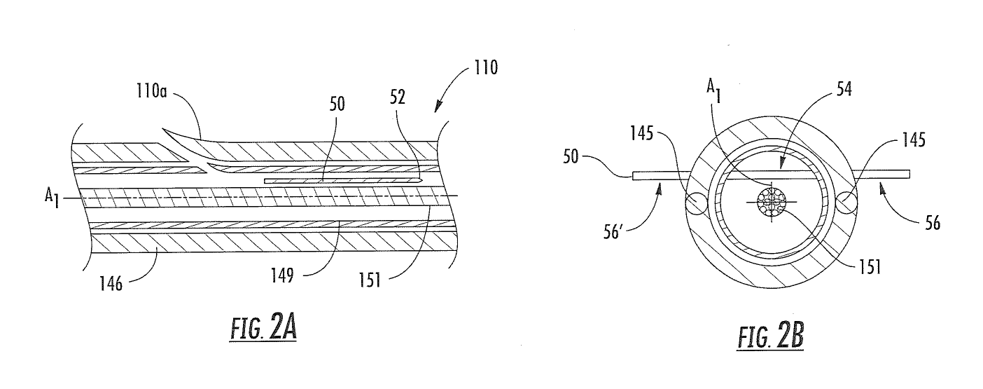

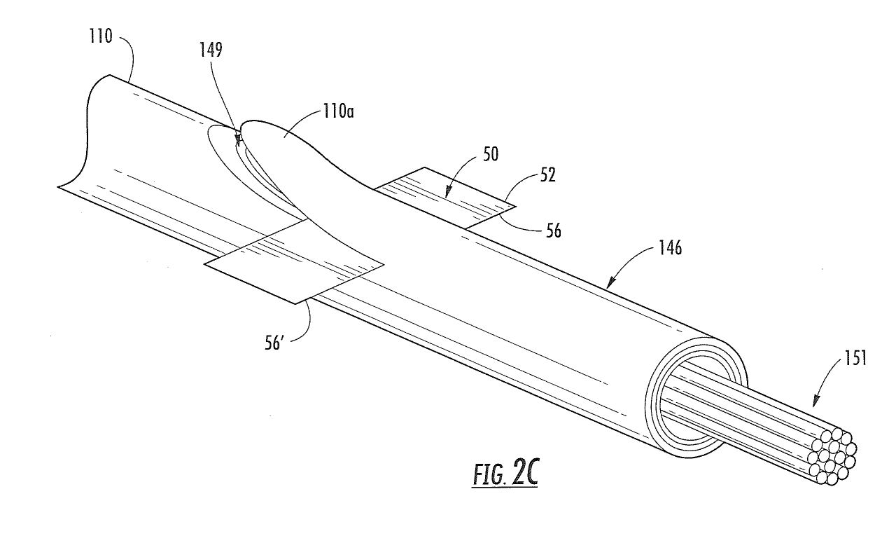

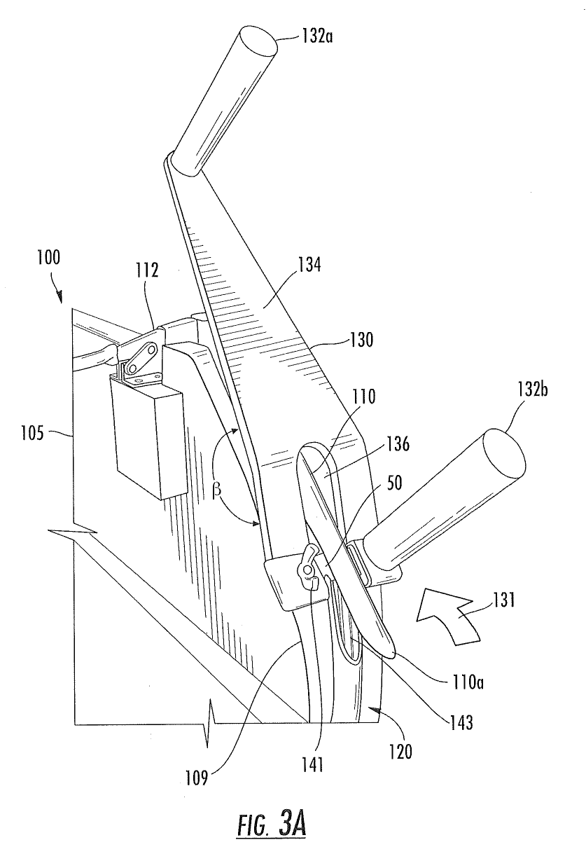

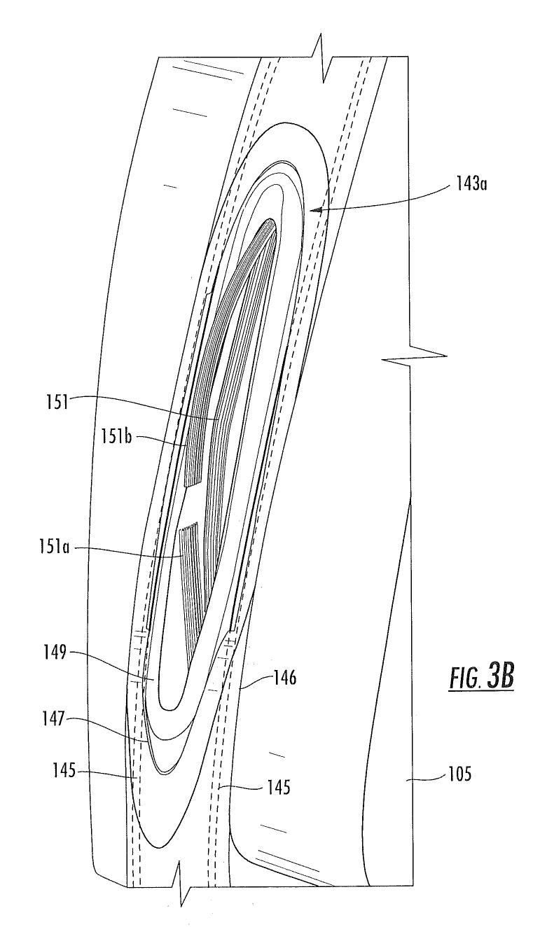

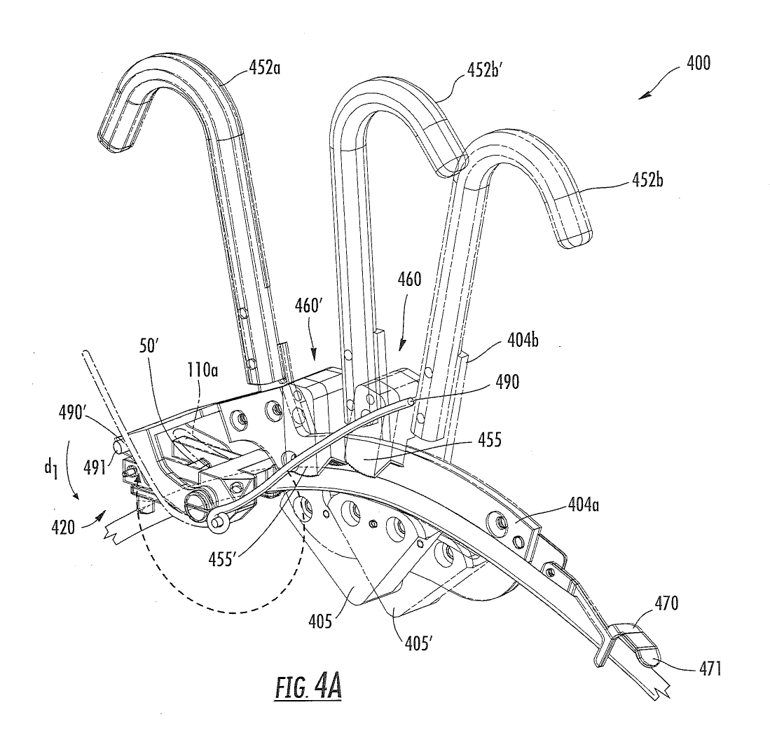

A cutter blade for use in an apparatus for accessing a length of a selected one of a plurality of optical fibers within an outer protective jacket of a cable including the plurality of optical fibers according to some embodiments of the present invention will now be further described with reference to FIGS. 1A through 2C. As seen in FIGS. 1A through 2C, an optical fiber cable 100 includes an outer protective jacket 146, a buffer tube, shown as a central core tube 149, a plurality of optical fibers 151 in the central core tube 149 and a pair of strength members 145 extending along opposite sides of a longitudinal axis A₁ of the cable 110 with the central core tube 149 and plurality of optical fibers 151 between the strength members 145. In other words, the plurality of optical fibers 151 are within (inside) the central core tube 149 while the strength members 145 are outside the central core tube 149.

In some embodiments of the present invention, a middle region of the cutter blade is configured to be less sharp than the outer side regions, which may be razor sharp. This middle region of the cutting edge of the cutter blade is only partially sharp and may, for example, have a cross-sectional radius at the cutting edge of between about 0.001 and 0.015 inches in radius. This portion of the blade may be configured to be sharp enough to puncture through the cable jacket and core tube materials when at the initial inclination angle, but not sharp enough to skive or damage the fibers or ribbon fibers contained inside the central core tube when it initially penetrates the central core tube, or traverses the cable at the substantially parallel orientation relative to the cable during the lengthwise cutting process. The outer side regions of the cutter blade on either side of the duller middle region may be sharpened to a conventional very sharp level so as to be able to slice through the cable jacket materials and central core tube material as the cutter traverses the cable length. In this manner the blade can scallop an extended portion of the cable jacket, the cable central core tube, and any other fibrous cable materials for an extended length to gain access to the fibers while limiting or even preventing damage to any of the fibers in the center of the cable core tube. Having sharper outer regions may allow for improved cutting efficiency/reduced cutting force requirements while still limiting the risk of damage to the fibers or ribbon fibers in the cable.

More particularly, as seen in FIGS. 1A through 2C, a cutter blade 50 of a length l has a cutting edge 52 of a width w along a leading edge thereof. The cutting edge 52 includes a middle region 54 having a width x and outer side regions 56, 56′ of a width y adjacent opposite sides of the middle region 54. The middle region 54 has a first sharpness and the outer side regions 56, 56′ have a second sharpness that is sharper than the first sharpness.

It will be understood that the cutter blade 50 will, in use, generally be positioned in a cutting member. The cutting member is not shown in FIGS. 1A through 2C so as to more clearly illustrate positioning of the cutter blade 50 relative to the cable 110 to remove a segment of the cable 110. FIGS. 1A and 1B illustrate the cutter blade 50 in a first position aligning the cutter blade to penetrate the cable 110 at an angle α of between about 10 and 50 degrees inclination relative to the longitudinal axis A₁ of the cable 110. FIGS. 2A through 2C illustrate the cutter blade 50 in a second position aligning the cutter blade substantially parallel to the longitudinal axis A₁ of the cable 110 after penetrating the cable outer jacket 146 and the central core tube 149.

In some embodiments, the sharpness of the middle region 54 is selected to be sharp enough, when advanced at an angle α relative to the longitudinal axis A₁ (or away from the longitudinal axis A₁ at an angle α to be advanced out of the cable 110) of the cable 110 to puncture through the outer protective jacket 146 and the central core (buffer) tube 149 but not sharp enough to damage the optical fibers 151. The sharpness of the outer side regions 56, 56′ may be selected to be sharp enough to slice through the outer protective jacket 146 and fibrous materials when advanced substantially parallel to the longitudinal axis A₁ of the cable 110. In particular embodiments, the middle region 54 of the cutting edge 52 has a radius at the cutting edge 52 of between about 0.001 and 0.015 inches in radius and the outer side regions 56, 56′ are razor sharp. In some embodiments, the outer side regions 56, 56′ may be between about 50 percent and about 300 percent sharper than the middle region 54. In some embodiments, the middle region 54 requires between about 1.5 and 3 times more force than the outer side regions 56, 56′ to cut or advance through the outer protective jacket 146 and the central core tube 149.

In some embodiments, the material of the cutter blade 50 is hardened steel, such as crucible formed steel CPM 10 V or CPM 9V, and is hardened by heat treating. Benefits of CPM10 V and 9V may include extremely hard surface to reduce wear, retaining razor sharpness over long period of use, and toughness combined with hardness to prevent shattering. As will be described further with reference to FIG. 10, the cutter blade 50 may include a straight or angled edge 52. References to sharpness with reference to radius herein refer to a radius as measure in a plane that is: a) perpendicular to the leading edge of the blade (at any given instance along a curved leading edge) and b) perpendicular to the plane of the body of the blade (i.e. the plane of the flat sheet of the main blade body).

As will be further described later herein, a cutting member including the cutter blade 50 may be used with a cable positioning fixture configured to receive a portion of the cable 110 therein and to establish a desired rotational (i.e., about the longitudinal axis of the cable) orientation of the portion of the cable 110 in the fixture relative to the strength member(s) 145 therein while the cutter blade 50 is longitudinally advanced along the portion of the cable 110 to remove a scalloped segment 110a from the outer protective jacket 146.

The desired rotational orientation for cables with a pair of strength members 145, as seen in FIGS. 1B and 2B, may be with the opposite sides of the cable 110 including the strength members 145 extending in a plane with each of the strength members 145 displaced by a substantially same vertical distance from a path followed by the cutter blade 50 relative to the portion of the cable 110 when removing the scalloped segment 110a so that a vertical position of the strength members 145 in the portion of the cable 110 relative to path followed by the cutter blade 50 limits a vertical depth of the scalloped segment 110a by substantially concurrent mechanical interference of the cutter blade 50 with both of the strength members 145.

The cutter blade 50 can be mounted in various cutting devices to facilitate the penetration at an entrance angle of between approximately 10 and 50 degrees, the traversing of the cable 110 substantially parallel to the cable axis A₁, and the exiting of the cable 110 at an upwards angle of approximately between 10 and 50 degrees. Also, gating devices may be employed peripherally to the blade 50 to ensure that the duller center portion 54 of the blade 50 remains substantially centered (relative to a transverse axis) at the axis A₁ of the cable central core tube 149 (which is the same as the axis of the cable 110) as it traverses lengthwise, such that the sharper portions 56, 56′ of the blade 50 do not stray towards the fibers 151 within the central core tube 149 and that the sharper portions 56, 56′ stay substantially or even completely outside of the diameter of the central core tube 149.

Embodiments of the present invention will now be further described with reference to

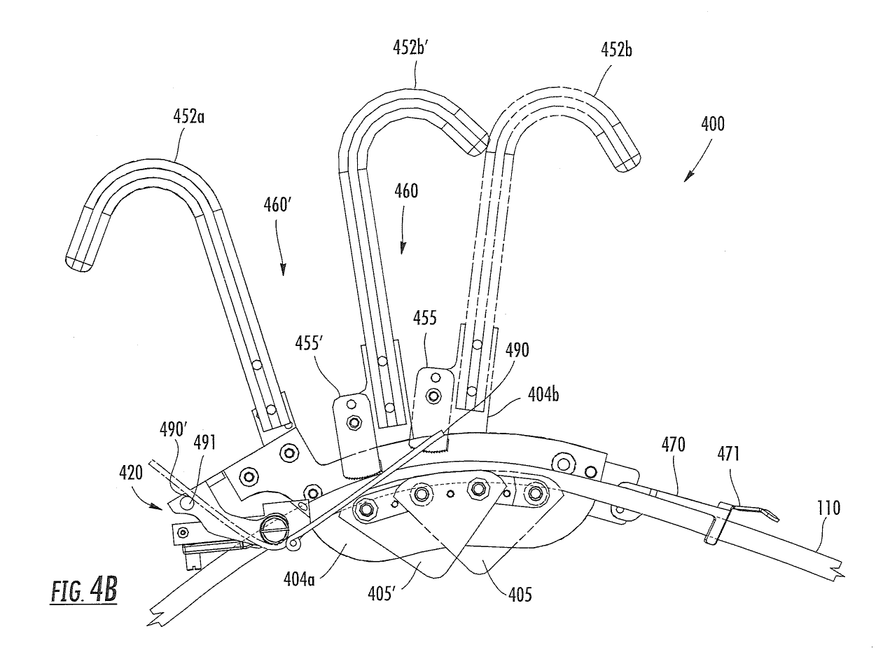

FIGS. 3A and 3B. FIG. 3A is a partial perspective view of an apparatus 100 for accessing a length of a selected one of a plurality of optical fibers within an outer protective jacket of a cable including the plurality of optical fibers showing a cutting member 130 for cutting into the cable 110. FIG. 3B is a perspective view showing in detail features within the cable 110 and further illustrating methods of accessing optical fiber within an optical fiber cable according to some embodiments of the present invention.

The apparatus 100 includes a cable positioning fixture 105 configured to receive a portion of an optical fiber cable 110 therein. The cable positioning fixture 105 establishes a desired rotational orientation of a portion of the cable 110 in the fixture 105 relative to one or more strength members extending within the cable 110 while the cutting member 130, including the cutter blade 50, removes a scalloped segment 110a from an outer protective jacket of the cable 110.

As best seen in FIG. 3B, the cable 110 may include an outer protective jacket 146, a metal shield layer 147, a central core tube 149 and a plurality of optical fibers within the central core tube 149, shown as optical fiber ribbons 151 in FIG. 3B. Also shown in the cable 110 in FIG. 3 is a pair of strength members 145 extending along opposite sides of the cable 110. The various described features of the illustrated cable 110 in FIG. 3 are visible in an opening 143a formed by removing the scalloped segment 110a.

A channel shaped region 120 is shown in the arched segments 109 that defines a contact surface receiving the cable 110 when the cable is secured in the fixture 105. Also shown in the embodiments of FIG. 3B is a clamp 112 that may be used to fixedly secure the cable 110 in the fixture 105 in the desired orientation before using cutting member 130 to remove the scalloped segment 110a. It will be understood that an additional clamp 112 may be provided to hold an opposite end of the cable 110 in position in the fixture 105, although such an additional clamp or clamps is not visible in FIG. 3B.

As used herein, references to a contact surface for the cable 110 in the fixture refers to a contact portion or points between the receiving region, such as the u-shaped channel 120, and the cable 110. For example, a U-shaped channel 120 (or v-shaped or the like channel) will generally have two contact points with the cable 110 on respective sides of the channel, which points of contact define a plane of the contact surface as used herein. Moreover, in some embodiments, a single point of contact may be provided by a channel surface or the like having sufficient width to fully receive or orient the cable 110 with respect to a single point of contact. In such embodiments, an associated plane of the contact surface refers to a plane extending substantially perpendicular to a central cross-sectional axis of the cable 110 as secured in the fixture 105.

As used herein, the contact surface may be used as a reference point for describing the desired orientation. For example, with respect to the cable 110 illustrated in FIG. 3B having a pair of strength members 145 extending along opposite sides of the cable, the desired orientation in some embodiments is with the opposite sides of the cable 110 including the strength members 145 extending in a plane substantially parallel to the abutting contact surface of the fixture so that a vertical position of the strength members 145 in the cable 110 relative to the abutting contact surface limits a vertical depth of the scalloped segment 110a relative to the abutting contact surface by substantially concurrent mechanical interference of the cutting member 130 with both of the strength members 145.

It will be understood that for a cable 110 including strength members 145 arranged as in FIG. 3B, wrapping of the cable 110 into an arch abutting the arched segment 109 orients the cable 110 in the desired position. In particular, for such arrangements of strength members as seen in FIG. 3, the cable 110 is generally highly resistant to bending along a first axis corresponding to a plane defined by the strength members 145 and more flexible and bendable in a plane perpendicular thereto. As a result, bending of the cable 110 around the arched section 109 may naturally orient the cable 110 relative to the strength members 145.

As also seen in FIG. 3B, one of the ribbon cables of optical fibers 151 has been cut to allow relative movements of ends 151a, 151b thereof. It will be understood that, as a result, a respective selected fiber or fibers may be spliced, for example, to an optical fiber or fibers in a drop cable or drop cables and the splices and openings may then be environmentally protected in a closure. Splices to respective drop cables may be accommodated on a splice tray or the like within the closure.

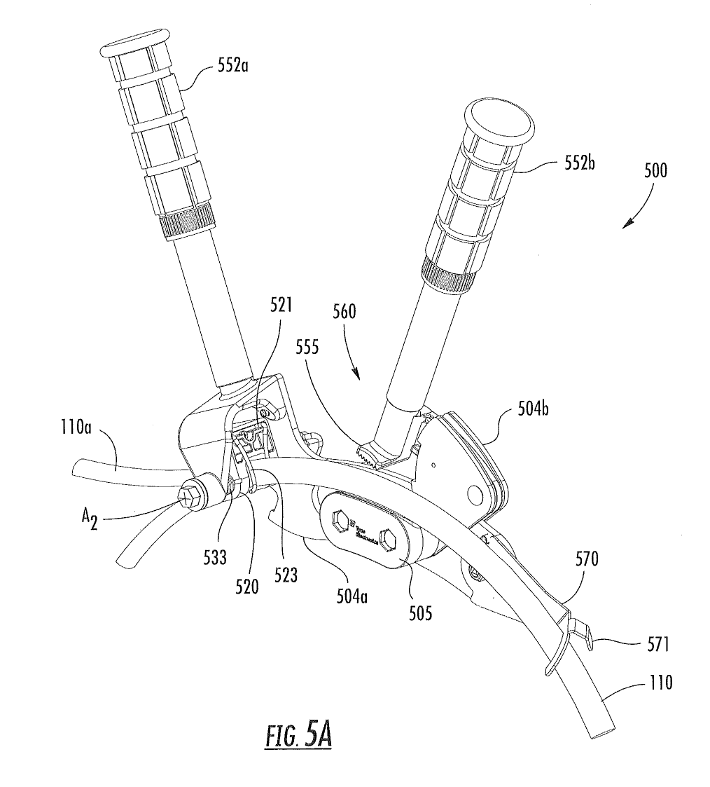

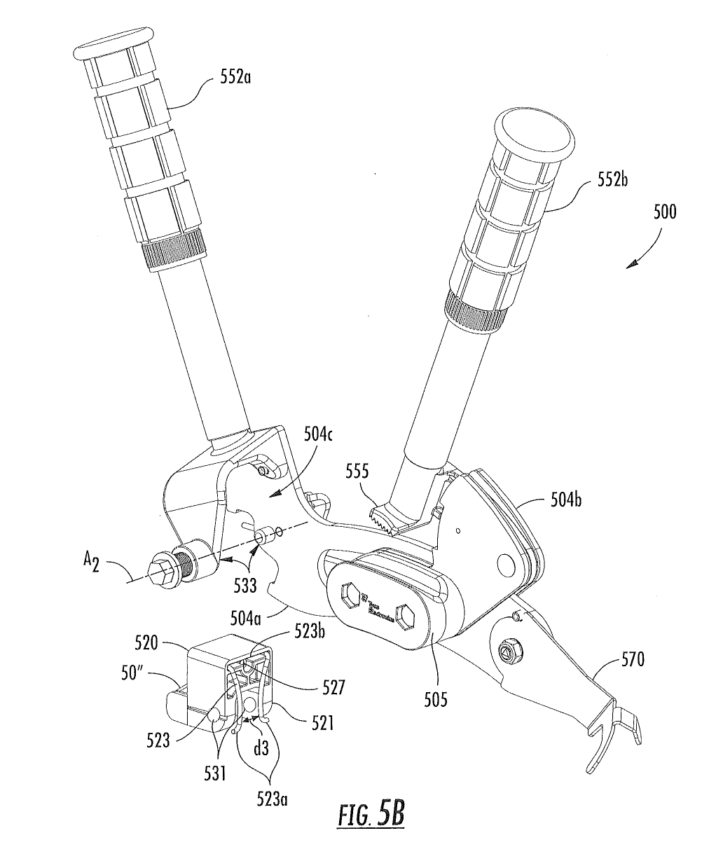

Further embodiments of an apparatus 400 for accessing a length of a selected one of a plurality of optical fibers 151 within an outer protective jacket 146 of a cable 110 will now be described with reference to FIGS. 4A and 4B. FIG. 4A is a perspective view of the apparatus 400. FIG. 4B is a front view of the apparatus 400 of FIG. 4A. In both figures the apparatus is shown in both a starting orientation and an advanced orientation (i.e, handle 452b and features moving therewith shown in an advanced orientation as handle 452b′ etc.). The apparatus 400 provides a cable positioning fixture including a pivotally mounted cutting member 420, with a cutter blade 50′ positioned therein, attached to a plate section 404a of the apparatus 400.

Apparatus 400, as with those described previously, receives a cable therein so as to establish a desired rotational orientation of the received portion of the cable 110 in the fixture relative to one or more strength members 145 within the cable while the cutting member 420 removes a scalloped segment 110a from the outer protective jacket 146 of the cable 110. An arched segment 405, 405′ of the apparatus 400 receives the portion of the cable 110. As was described previously, in the embodiments of FIGS. 4A and 4B, the cable 110 may include a pair of strength members 145 extending along opposite sides and the desired orientation provided in the apparatus 400 may be with the opposite sides of the cable 110 including the strength members 145 extending in a plane substantially parallel to an abutting contact surface on the arched segment 405, 405′ of the apparatus 400. As such, a vertical position of the strength member in the portion of the cable relative to the abutting contact surface may limit a vertical depth of the scalloped segment 110a relative to the abutting contact surface by substantially concurrent mechanical interference of the cutter blade 50′ with both of the strength members.

The apparatus 400 of FIGS. 4A and 4B is illustrated as having a securing member 460, 460′, including the arched segment 405, 405′ and a grip member 455, 455′. The illustrated securing member 460, 460′ also includes a plate section 404c, to which the arched segment 405, 405′ is connected. As seen in the embodiments of FIGS. 4A and 4B, the securing member 460, 460′ is driven by a manual drive member, shown as handles 452a and 452b, 452b′ in FIGS. 4A and 4B, through the drive coupling plate section 404c. Note that actuation of the handle 452b, 452b′ towards the handle 452a may operate both to secure the cable 110 in the securing member 460, 460′ and to advance the secured cable 110 along a defined path relative to the cutting member 420 to remove the scalloped segment 110a from the outer protective jacket 146 of the cable 110.

The apparatus 400 of FIGS. 4A and 4B further includes an anti-backup member 470. The anti-backup member 470 is configured to allow a secured portion of the cable 110 to pass therethrough in a first direction to receive a portion of the cable 110 in the apparatus 400 and to limit movement of the secured cable in a second opposite direction. Furthermore, the securing member 460 is configured to allow the drive coupling plate section 404c to return with the securing member 460, 460′ to the start position from the finish position without moving the secured portion of the cable 110 away from the cutting member 420 as described with reference to other embodiments above. A finger lift handle 471 is shown that may be used to facilitate placement of the cable 110 in the anti-backup member 470. The anti-backup member 470 is coupled to the plate section 404a by a bolt.

The apparatus 400 includes the cutting member 420 pivotally coupled to the first base plate section 404a for movement between a cutting orientation selected to position the cutter blade 50′ therein to cut into the outer protective jacket 146 when the cable 110 is moved along the defined path, as illustrated in FIG. 4A and an extracted orientation selected to allow removal of the cutter blade 50′ from the outer protective jacket 146. More particularly, the cutting member 420 may be pivotally rotated in a direction d₁ to facilitate removal of the cutter blade 50′ of the cutting member 420 from the outer protective jacket 146 on completion of forming the opening 143. Also shown in FIGS. 4A and 4B is a selection lever spring member 490, 490′, shown as an end of a clock spring, for imposing a force to aid movement of the cutter blade 50′ from the outer protective jacket. In the position shown as selection lever 490, no rotational force is imposed. In the position shown as selection lever 490′ with the selection lever 490′ positioned under the pin 491, a rotational force is imposed so the cutter blade 50′ will be removed from the cable 110 as the cable 110 advances relative to the cutter blade 50′.

Other aspects of the apparatus of FIGS. 1A through 4B are described in co-pending U.S. patent application Ser. No. 12/194,178, filed Aug. 19, 2008, the disclosure of which is incorporated be reference herein as if set forth in its entirety.

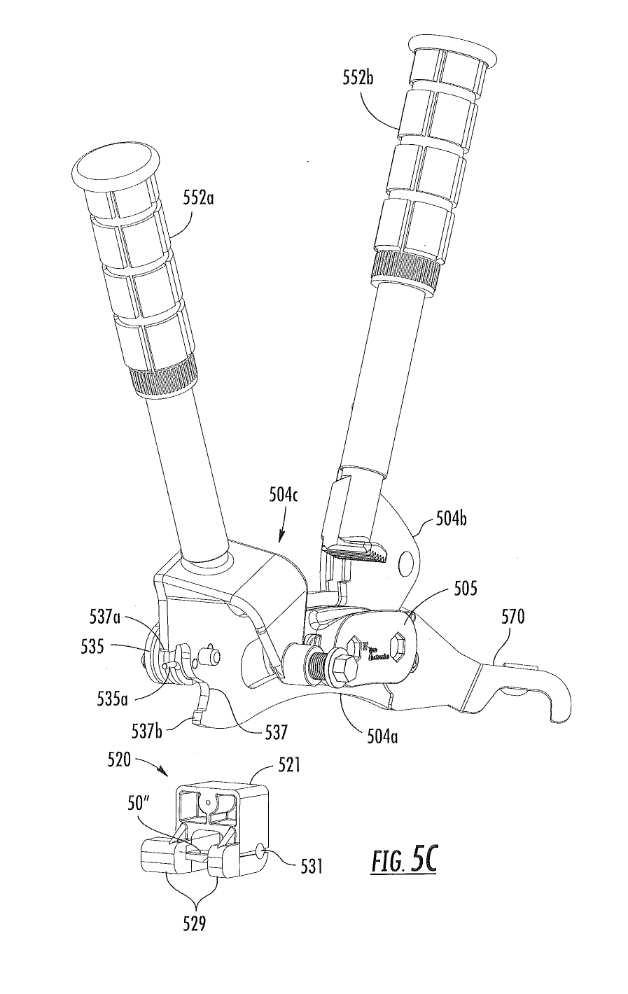

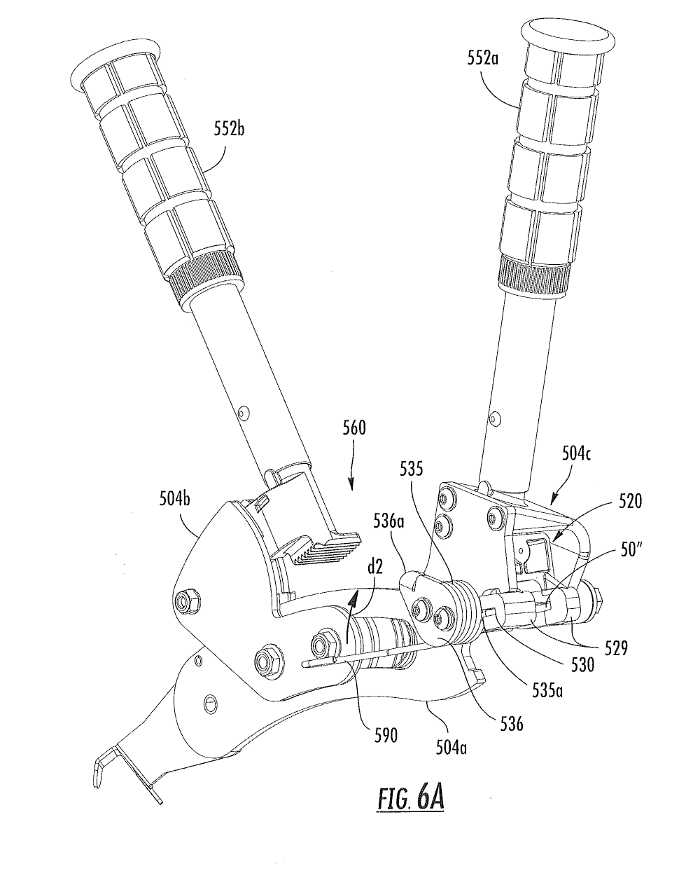

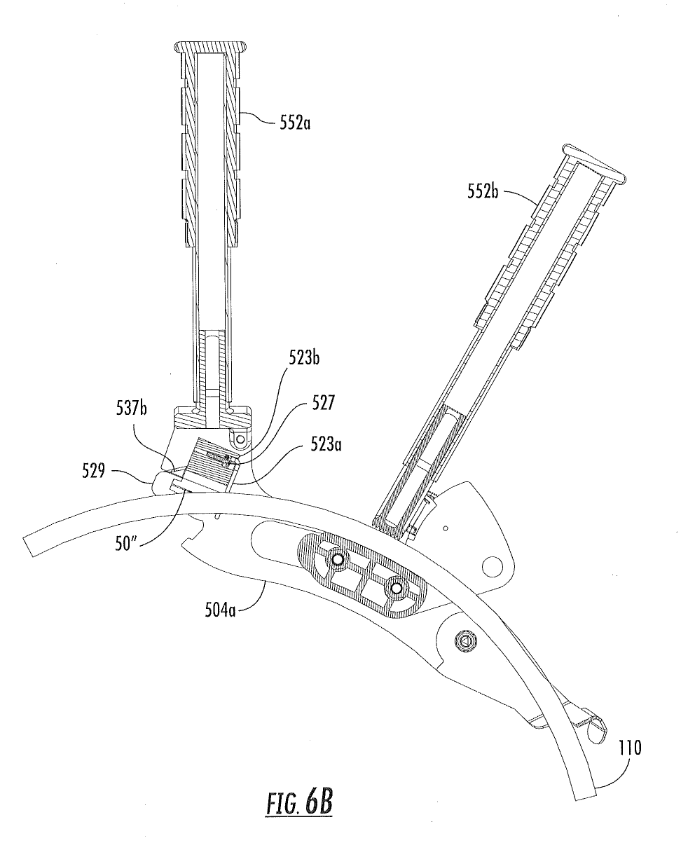

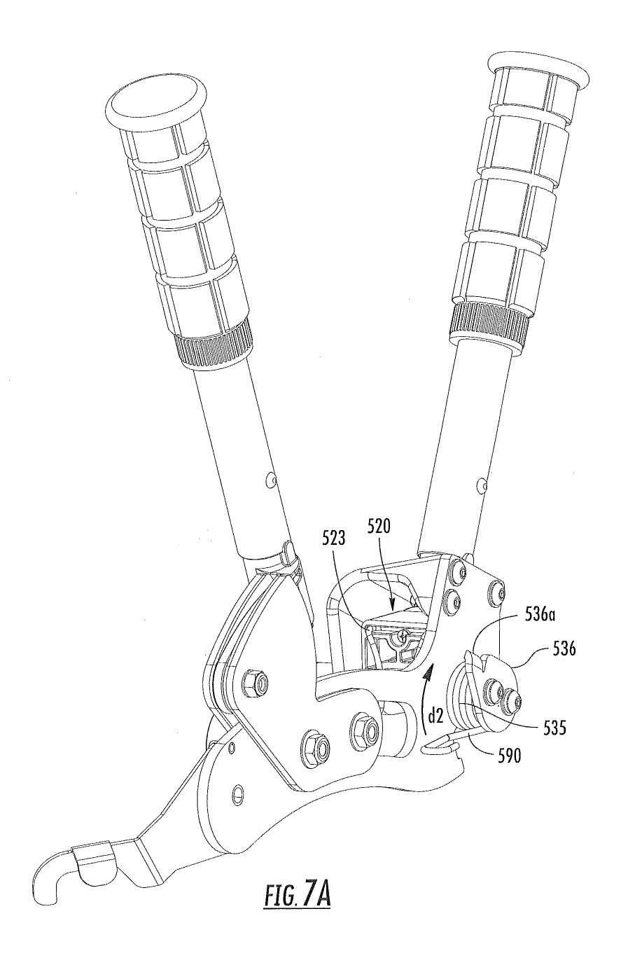

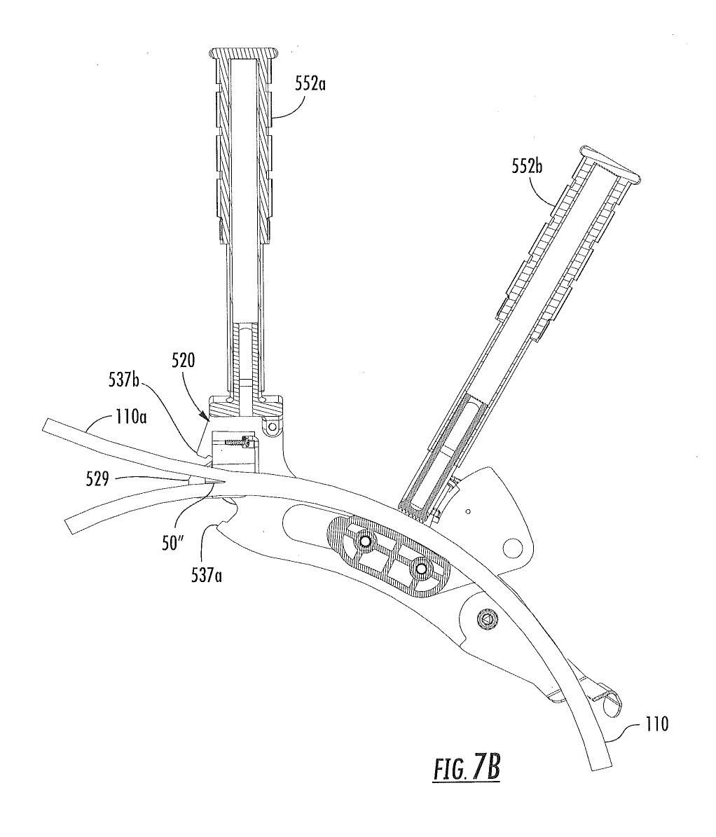

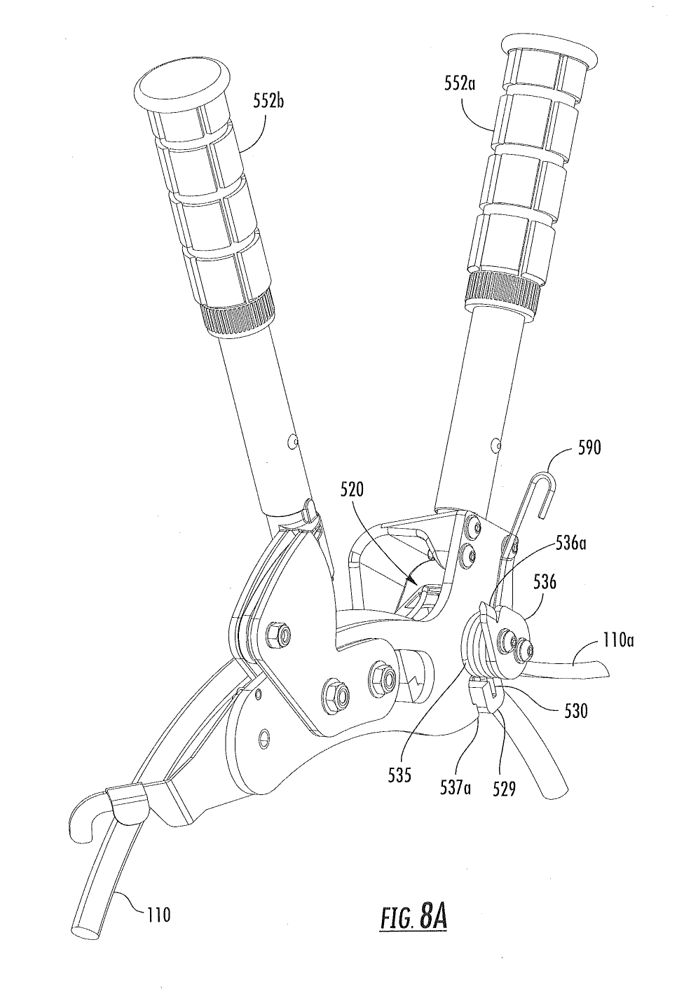

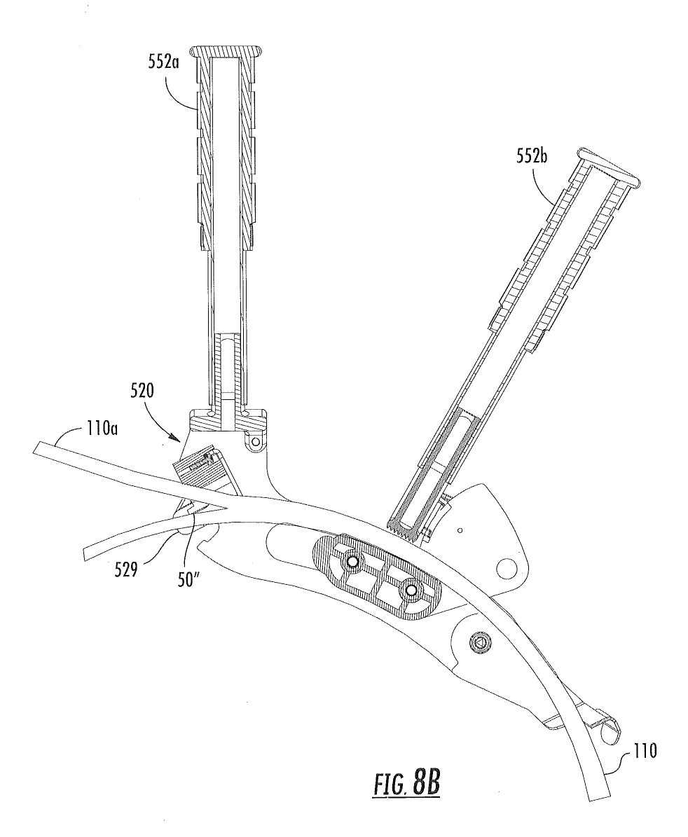

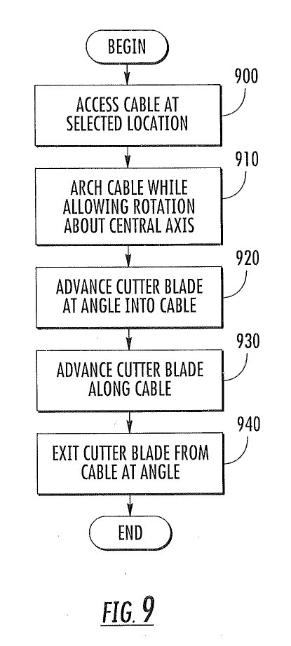

Further embodiments of an apparatus 500 for accessing a length of a selected one of a plurality of optical fibers 151 within an outer protective jacket 146 of a cable 110 will now be described with reference to FIGS. 5A through 8B. FIG. 5A is a perspective view of the apparatus 500. FIGS. 5B and 5C are partially exploded perspective views of the apparatus of FIG. 5A. FIGS. 6A and 6B illustrate the apparatus of FIG. 5A with a cutting member 520 aligned to enter a cable 110. FIGS. 7A and 7B illustrate the apparatus 500 of FIG. 5A with the cutting member 520 traversing the cable 110 in a second position and FIGS. 8A and 8B illustrate the apparatus 500 of FIG. 5A with the cutting member 520 positioned to exit the cable 110 after forming an opening therein. Like numbered features (e.g. 452A, 552A) in FIGS. 5A through 8B generally correspond to those described previously with reference to FIGS. 4A and 4B except as described further herein.

As described with reference to the apparatus 400 of FIGS. 4A and 4B, the apparatus 500 of FIGS. 5A through 8B receives a portion of the cable 110 therein to establish a desired rotational orientation of the portion of the cable 110 in the apparatus 500 relative to the strength member(s) 145 therein. More particularly, the cable 110 is engaged at a first end by an anti-backup member 570 having a lift handle 571 and at a second end by the cutting member 520, with an arched segment 505 positioned on the lower side of the cable 110 therebetween to establish a bending of the cable. Such bending causes rotation of the cable 110 about the longitudinal axis A₁ of the cable to establish the desired rotational orientation of the cable 110. The relative positioning of the contact points 505, 520, 570 defines the bending radius.

As best seen in FIGS. 5B and 5C, the apparatus 500 includes the cutting member 520, with a cutter blade 50″ positioned in the cutting member 520. As was previously described with reference to FIGS. 1A through 1C, the cutter blade 50″ has a cutting edge 52 with a middle region 54 of a first sharpness and outer side regions 56, 56′, adjacent opposite sides of the middle region 54, of a second sharpness that is sharper than the first sharpness. The first sharpness of the middle region 54 may be selected to be sharp enough when advanced at an angle relative to the longitudinal axis A1 of the cable 110 to puncture through the outer protective jacket 146, but not sharp enough to damage the optical fiber 151. The second sharpness of the outer side regions 56, 56′ is selected to be sharp enough to slice through the outer protective jacket 146 when advanced substantially parallel to the longitudinal axis A1 of the cable 110, as seen in FIGS. 7A and 7B. In some embodiments, the middle region 54 of the cutting edge 52 has a radius of the cutting edge of between about 0.001 and 0.015 inches in radius and the outer side regions 56, 56′ are razor sharp. It will also be understood that, in embodiments where the cable 110 includes the central core tube 149, the first sharpness of the middle region 54 is also selected to be sharp enough when advanced at an angle relative to the longitudinal axis A1 of the cable 110 to puncture through the central core tube 149, as seen in FIGS. 6A and 6B.

Also seen in the embodiments in FIGS. 5B and 5C, a gating device 523 is provided that is configured to limit lateral movement of the cutter blade 50″ relative to the longitudinal axis A₁ of the cable 110 to maintain the middle region 54 of the cutting edge 52 substantially centered relative to the longitudinal axis A₁ of the cable and maintain the outer side regions 56, 56′ transversely substantially outside of the central core tube when the cutting device is moved along the longitudinal axis A1 of the cable to remove a scalloped segment from the outer protective jacket 146.

More particularly, the gating device 523 in the embodiments illustrated in FIGS. 5A through 8B is a cable centering fixture 523 that is coupled to the cutting member 520. The cable centering fixture 523 has first and second retaining arms 523a with a connecting arm 523b extending therebetween. The cable centering fixture 523 is coupled to the cutting member 520 at the connecting arm 523b by a screw 527 in the illustrated embodiments. As seen in the figures, the first and second retaining arms 523a are spring steel members with a lateral distance d₃ therebetween selected to receive a selected range of diameters of cables 110. The arms 523a may flex beyond the diameter d₃ to receive a cable 110 with a diameter greater than the nominal distance d₃ of the spring arms 523a when they are not flexed.

As best seen in FIGS. 5B and 5C, the apparatus 500 defines a fixture that includes plates section 504a and 504b coupled, respectively, to handle 552a and 552b. A securing member 560 includes the arched section 505 and grip member 555 coupled to the plate section 504b as described previously with respect to the like numbered items in FIGS. 4A and 4B. In addition, a cutting member receiving a portion 504c is shown in the apparatus 500 that is configured to rotationally mount the cutting member 520 in the apparatus about a rotation axis A₂. The body 521 of the cutting member 520 includes a passageway 531 therein that is pivotally received on corresponding members 533 of the cutting member receiving portion 504c. The members 533 are shown as a cylindrical tab screwed to the plate 504a on one side and a bolt on the other side in the embodiments shown in FIGS. 5B and 5C. The respective members 533 are received in the passageway 531 of the cutting member 520 and allow pivotal movement of the cutting member 520 about the rotation axis A₂.

As such, the cutting member 520, when installed, is configured to automatically pivot between a first rotational position shown in FIGS. 6A and 6B to a second position shown in FIGS. 7A and 7B. In the first position shown in FIGS. 6A and 6B the cutting member 520 aligns the cutter blade 50″ therein to penetrate the cable 110 at an angle of between about 10 and 50 degrees inclination relative to the longitudinal axis A₁ of the cable 110. In the second position shown in FIGS. 7A and 7B the cutting member 520 is free to rotate and allows the cutter blade 50″ to be aligned substantially parallel to the longitudinal axis A1 of the cable after penetrating the cable outer jacket 146 and the central core tube 149 for movement along the longitudinal axis.

In the illustrated embodiments of FIGS. 5A through 8B, the cutting member 520 is configured to automatically pivot between the first position of FIGS. 6A and 6B and the second position of FIGS. 7A and 7B responsive to contact of the cutter blade 50″ with the strength members 145 in the cable 110. As such, the strength members 145 shown in FIG. 1B are positioned to limit the vertical depth of the scalloped segment 110A by substantially concurrent mechanical interference of the cutter blade 50″ with both of the strength members 145. The cutting member 520 is further configured to pivot from the second position shown in FIGS. 7A and 7B to a third position seen in FIGS. 8A and 8B. In the third position shown in FIGS. 8A and 8B, the cutting member 520 aligns the cutter blade 50″ to exit the cable 110 at an angle of between about 10 and 50 degrees. Note, however, that the transition of the cutting member 520 between the first, second and third positions, when a cable is in position as shown schematically in the figures, relies upon relative motion between the handles 552a and 552b to allow the cutter blade 50″ to change position and orientation by passing through the outer jacket 146 material. In other words, as semantically illustrated in FIG. 8B, the change in angle requires displacement of the portion 110A of the cable 110 to allow a change in angle of the blade 50″. As such, in use, when originally setup to transition to the third position shown in FIG. 8B, as will be now described, the angle of the cutting member 520 does not change. The change occurs on motion of the handle 552b toward the handle 552a while the cutting member 520 is biased to assume the position shown in FIGS. 8A and 8B.

Components of the apparatus 500 related to the transition and the moving of the cutting member 520 between the first, second and third positions will now be described further for the illustrated embodiments with references to FIGS. 5C, 6A, 7A and 8A. As best seen in FIG. 5C, the cutting member receiving portion 504c in the apparatus 500 includes a channel 537 having a first stop end 537a and an opposite second stop end 537b. In addition, a clock spring member 535 is positioned on the rotation axis A₂ of the cutting member 520. The clock spring member 535 has a retaining tab 535a at one end thereof and a selection lever 590 at a second, opposite end thereof. The retaining tab 535a of the clock spring member 535 is positioned approximate the channel 537 as best seen in FIGS. 6A and 8A.

The body 521 of the cutting member 520 further includes a rotational travel limit member 529 that is positioned in the channel 536. The travel limit member 529 limits rotary movement of the cutting member about the rotation axis A2 by contact of the travel limit member 529 with the first stop end 537a of the channel when the cutting member 520 is in the first position seen in FIG. 6A. The travel limit member 529 limits rotary movement by contact with the second stop end 537b of the channel of the channel 537 when the cutting member 520 is in the third position shown in FIG. 8A.

As seen by comparing FIG. 6A or 7A to FIG. 8A, the selection lever 590 of the spring member 535 is moveable between a first position, shown in FIG. 8A, and a second position, shown in FIGS. 6A and 7A. In the first position, the spring member 535 places an amount of torque on the cutting member sufficient to move the cutting member to the third position shown in FIG. 8A to exit the cable. When the selection lever 590 is in the second position shown in FIGS. 6A and 7A, the spring member 535 does not place enough torque to move the cutting member 520 to the third position shown in FIG. 8A. In some embodiments, in the first position of the selection lever 590 when the cutting member 520 is either in the first position of FIG. 6A or the second position of FIG. 7A, the spring member 535 does not impose any torque on the cutting member 520. The material of the spring member 535 may be regular spring stock wire, which may be ferrous or stainless steel.

Also shown in FIGS. 6A, 7A and 8A is a clock spring member retaining plate 536 with a tab 536a thereon. As seen in FIG. 8A, the selection lever 590 is retained in the position shown in FIG. 8A by being placed in contact with and retained by the tab 536a.

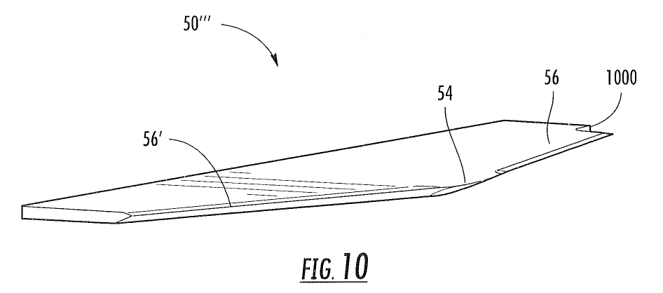

Embodiments of methods of accessing an optical fiber within an optical fiber cable will now be described with reference to the flowchart illustration of FIG. 9. Referring to the flowchart illustration of FIG. 9, operations begin at block 900 by accessing a portion of the cable at a selected location. The cable includes a plurality of optical fibers and at least one strength member extending longitudinally within an outer protective jacket as seen, for example, in FIG. 3B. The portion of the cable is arched while allowing rotation about a central axis of the cable to establish a desired rotational orientation of the portion of the cable relative to the pair of strength members (block 910). The desired orientation may be with opposite sides of the cable including strength members positioned at a substantially same vertical position relative to a cutting member used to remove the scalloped segment. A scalloped segment of the outer protective jacket is removed at a selected location on the portion of the cable while the portion is in the desired orientation without cutting any of the plurality of optical fibers or the pair of strength members to provide an opening as will now be described with reference to blocks 920 to 950. Removing the scalloped segment may include forming the opening with the cutting member to a vertical depth not exceeding the vertical position of the strength members in the portion of the cable

A cutting member is advanced into the cable 110 with an edge 52 of a cutter blade 50, 50′, 50″ In the cutting member at an angle of between about 10 and 50 degrees inclination relative to the longitudinal axis A₁ of the cable 110 until the cutter blade 50, 50′, 50″ contacts the pair of strength members 145 (block 920). The cutting edge includes a middle region of a first sharpness and outer side regions adjacent opposite sides of the middle region of a second sharpness that is sharper than the first sharpness. The cutting member is then advanced longitudinally along the cable 110 with the edge 52 of the cutter blade 50, 50′, 50″ substantially parallel to the longitudinal axis A₁ of the cable after penetrating the cable outer jacket 146 (block 930). The cutter blade is then exited from the cable 110 at an angle of between about 10 and 50 degrees inclination relative to the longitudinal axis A₁ of the cable 110 after a desired length of the outer jacket 146 has been removed to provide a selected size for the opening (block 940).

Further embodiments of a cutter blade 50′″ are shown in FIG. 10. The embodiments of FIG. 10 differ from the cutter blade 50 of FIGS. 1A to 1C in that the outer portions 56, 56′ of the cutting edge 52 extend away from the middle portion 54 at an angle. Also shown in FIG. 10 is a notch 1000 that may be used to prevent the blade 50′″ from being placed in the cutting member 520 incorrectly, such as upside down. The curved leading edge of the cutter blade 50′″ resulting from the angled outer portions 56, 56′ may facilitate the initial penetration of the cutter blade 50′″ into the cable jacket at entry.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed:

1. An apparatus for accessing a length of a selected one of a plurality of optical fibers within an outer protective jacket of a cable including the plurality of optical fibers and at least one strength member extending along a longitudinal axis of the cable, the apparatus comprising:
a cutting member; and
a cutter blade positioned in the cutting member having a cutting edge with a middle region of a first sharpness and outer side regions adjacent opposite sides of the middle region of a second sharpness that is sharper than the first sharpness.

2. The apparatus of claim 1, further comprising a cable positioning fixture configured to receive a portion of the cable therein and to establish a desired rotational orientation of the portion of the cable in the fixture relative to the at least one strength member therein while the cutter blade is longitudinally advanced along the portion of the cable to remove a scalloped segment from the outer protective jacket.

3. The apparatus of claim 2, wherein the first sharpness of the middle region is selected to be sharp enough, when advanced at an angle relative to the longitudinal axis of the cable to puncture through the outer protective jacket but not sharp enough to damage the optical fibers while removing a scalloped segment from the cable and wherein the second sharpness of the outer side regions is selected to be sharp enough to slice through the outer protective jacket when advanced substantially parallel to the longitudinal axis of the cable.

4. The apparatus of claim 3, wherein the middle region of the cutting edge has a radius at the cutting edge of between about 0.001 and 0.015 inches in radius and wherein the outer side regions are razor sharp.

5. The apparatus of claim 3, wherein the cable further comprises a central core tube and wherein the at least one strength member comprises a pair of strength members extending along opposite sides of the cable and wherein the plurality of optical fibers are within the central core tube and the pair of strength members is outside the central core tube and wherein the first sharpness of the middle region is selected to be sharp enough, when advanced at an angle relative to the longitudinal axis of the cable to puncture through the central core tube.

6. The apparatus of claim 5, further comprising a gating device configured to limit lateral movement of the cutter blade relative to the longitudinal axis of the cable to maintain the middle region of the cutting edge substantially centered relative to the longitudinal axis of the cable and to maintain the outer side regions transversely substantially outside of the central core tube when the cutting device is moved along the longitudinal access of the cable to remove a scalloped segment from the outer protective jacket.

7. The apparatus of claim 6, wherein the gating device comprises a cable centering fixture coupled to the cutting member and having first and second retaining arms positioned to receive the cable therebetween to limit lateral movement of the cable relative to the cutting member.

8. The apparatus of claim 7, wherein the first and second retaining arms comprise spring steel members with a lateral distance therebetween selected to receive a selected range of diameters of cables.

9. The apparatus of claim 5, wherein the cutting member is configured to automatically pivot between a first position aligning the cutter blade therein to penetrate the cable at an angle of between about 10 and 50 degrees inclination relative to the longitudinal axis of the cable and a second position aligning the cutter blade therein substantially parallel to the longitudinal axis of the cable after penetrating the cable outer jacket and the central core tube.

10. The apparatus of claim 9, wherein the cutting member is further configured to pivot from the second position to a third position aligning the cutter blade therein to exit the cable at an angle of between about 10 and 50 degrees.

11. The apparatus of claim 10, wherein the cable positioning fixture further comprises:
a cutting member receiving portion configured to rotationally mount the cutting member in the fixture about a rotation axis;
a clock spring member positioned on the rotation axis, the clock spring member having a retaining tab at one end thereof and a selection lever at a second, opposite end thereof; and
a channel having a first stop end and an opposite second stop end, wherein the retaining tab of the clock spring member is positioned proximate the channel; and
wherein the cutting member further comprises a rotational travel limit member positioned in the channel that limits rotary movement of the cutting member about the rotation axis by contact of the travel limit member with the first stop end of the channel when the cutting member is in the first position and with the second stop end of the channel when the cutting member is in the third position, wherein the cutting member is configured to connect to the retaining tab of the spring member and wherein the selection lever of the spring member is movable between a first position, in which the spring member places an amount of torque on the cutting member sufficient to move the cutting member to the third position to exit the cable, and a second position, in which the spring member does not place enough torque on the cutting member to move the cutting member to the third position.

12. The apparatus of claim 11, wherein the cutting member comprises a molded plastic member and wherein the cutting blade is molded into the cutting member.

13. The apparatus of claim 8, wherein the cutting member is configured to automatically pivot between the first position and the second position responsive to contact of the cutter blade with the pair of strength members.

14. The apparatus of claim 13, wherein the desired rotational orientation is with the opposite sides of the cable including the strength members extending in a plane with each of the strength members displaced by a substantially same vertical distance from a path followed by the cutting member relative to the portion of the cable when removing the scalloped segment so that a vertical position of the strength members in the portion of the cable relative to path followed by the cutting member limits a vertical depth of the scalloped segment by substantially concurrent mechanical interference of the cutter blade with both of the strength members.

15. The apparatus of claim 1, wherein the cutting member is configured to automatically pivot between a first position aligning the cutter blade therein to penetrate the cable at an angle of between about 10 and 50 degrees inclination relative to the longitudinal axis of the cable and a second position aligning the cutter blade therein substantially parallel to the longitudinal axis of the cable after penetrating the cable outer jacket and the central core tube and to pivot from the second position to a third position aligning the cutter blade therein to exit the cable at an angle of between about 10 and 50 degrees.

16. The apparatus of claim 1, wherein the first sharpness of the middle region is selected to be sharp enough, when advanced at an angle relative to the longitudinal axis of the cable to puncture through the outer protective jacket but not sharp enough to damage the optical fibers and wherein the second sharpness of the outer side regions is selected to be sharp enough to slice through the outer protective jacket when advanced substantially parallel to the longitudinal axis of the cable.

17. The apparatus of claim 16, wherein the middle region of the cutting edge has a radius at the cutting edge of between about 0.001 and 0.015 inches in radius and wherein the outer side regions are razor sharp.

18. A cutter blade for accessing a length of a selected one of a plurality of optical fibers within an outer protective jacket of a cable including the plurality of optical fibers and at least one strength member extending along a longitudinal axis of the cable, the cutter blade comprising:
a cutting edge with a middle region of a first sharpness and outer side regions adjacent opposite sides of the middle region of a second sharpness that is sharper than the first sharpness, wherein the first sharpness of the middle region is selected to be sharp enough, when advanced at an angle relative to the longitudinal axis of the cable to puncture through the outer protective jacket but not sharp enough to damage the optical fibers while removing a scalloped segment from the cable and wherein the second sharpness of the outer side regions is selected to be sharp enough to slice through the outer protective jacket when advanced substantially parallel to the longitudinal axis of the cable.

19. The cutter blade of claim 18, wherein the middle region of the cutting edge has a radius at the cutting edge of between about 0.001 and 0.015 inches in radius and wherein the outer side regions are razor sharp.

20. The cutter blade of claim 18, wherein the outer side regions of the cutting edge extend at an angle away from the middle region.

21. The cutter blade of claim 18, wherein the outer side regions of the cutting edge are between about 50 percent and about 300 percent sharper than the middle region.

22. An apparatus for accessing a length of a selected one of a plurality of optical fibers within an outer protective jacket of a cable including the plurality of optical fibers and at least one strength member extending along a longitudinal axis of the cable, the apparatus comprising:
a cutting member; and
a cutter blade in the cutting member that is configured to puncture through the outer protective jacket of the cable at an angle relative to the longitudinal axis of the cable and to slice through the outer protective jacket when advanced substantially parallel to the longitudinal axis of the cable without damaging the optical fibers while removing a scalloped segment from the cable.

23. A method of accessing an optical fiber within an optical fiber cable, comprising:
accessing a portion of the cable at a selected location, wherein the cable includes a plurality of optical fibers and a pair of strength members extending longitudinally within an outer protective jacket along opposite sides of the cable;
arching the portion of the cable while allowing rotation about a central axis of the cable to establish a desired rotational orientation of the portion of the cable relative to the pair of strength members;
removing a scalloped segment of the outer protective jacket at a selected location on the portion of the cable while the portion is in the desired rotational orientation without cutting any of the plurality of optical fibers or the pair of strength members to provide an opening, including:
advancing a cutting member into the cable with an edge of a cutter blade in the cutting member at an angle of between about 10 and 50 degrees inclination relative to the longitudinal axis of the cable until the cutter blade contacts the pair of strength members; and then
advancing the cutting member longitudinally along the cable with the edge of the cutter blade substantially parallel to the longitudinal axis of the cable after penetrating the cable outer jacket; and then
exiting the cutter blade from the cable at an angle of between about 10 and 50 degrees inclination relative to the longitudinal axis of the cable after a desired length of the outer jacket has been removed to provide a selected size for the opening,
wherein the desired rotational orientation is with the opposite sides of the cable including the strength members positioned at a substantially same vertical position relative to a cutting member used to remove the scalloped segment and wherein removing the scalloped segment comprises forming the opening with the cutting member to a vertical depth not exceeding the vertical position of the strength members in the portion of the cable and wherein the cutting edge includes a middle region of a first sharpness and outer side regions adjacent opposite sides of the middle region of a second sharpness that is sharper than the first sharpness.
